(19) United States
(12) Patent Application Publication
(10) Pub. No.: US 2006/0288953 A1
(43) Pub. Date: Dec. 28, 2006

(54) Portable pet hotel

(76) Inventor: Cheryl Lynn Bottorff, Interlochen, MI (US)

Correspondence Address: Cheryl Lynn Bottorff, 4135 Central Avenue, Interlochen, MI, 49643, US

(21) Appl. No.: 11/167,511

(22) Filed: Jun. 27, 2005

(51) Int. Cl. A01K 1/03

(52) U.S. Cl. 119/497

(57) ABSTRACT

Our product is a soft-shelled, “suitcase-type” object, designed with nylon-type fabric, which is treated with a heavy urethane backcoating and a durable water repellent topical/surface. This fabric is durable, washable, and lightweight and is especially designed to enhance the pet owner's décor, available in many colors. The outside pouch is designed with an adjustable, comfortable, durable shoulder strap and two comfortable, soft handles for easy carrying, has two rust-resistant zippered compartments designed to hold all the pet's travel and at home essentials: food/water bowls, treats, snacks, leash, etc. The inside of the product is divided into two halves; one half contains an easily removable, contoured washable pet bed (available in many colors); the other half contains durable, washable, spill-proof food/water bowls on one side and an additional rust-resistant zippered pouch for pet items on the other side.

This invention is a compact, complete and convenient unit and is a must for every dog or cat owner, designed mainly for the traveling pet and his/her owner, but can be used at home too.

The vision of this inventor is to provide comfort, reduce anxiety and stress and make the overall life of the cat or dog and its owner more carefree and less hassled, thereby providing more time between the human and their pet. We believe our first responsibility is to all pets, but our product is designed for dogs and cats, emphasizing the fact that the use of our product can ease the anxiety a pet has mainly while traveling, but can be used at home too.

Our product consists of a soft-shelled, “suit-case type” object with one rust-resistant zipper that opens the entire unit, and is designed with nylon-type material, which is treated with a heavy urethane backcoating and is of a durable water repellent topical/surface. This fabric is durable, washable, and lightweight and is especially designed to enhance the pet owner's décor available in many colors. The outside pouch, designed with a comfortable, durable shoulder strap and two comfortable, soft handles for easy carrying, has two rust-resistant zippered compartments designed to hold all the pet's travel and at home essentials: food/water bowls (included), treats, snacks, leash, etc. The inside of the product is divided into two halves; one-half contains an easily removable, contoured washable pet bed with a removable cover that has a rust-resistant zipper for easy removal that comes in many colors. The other half contains durable, washable, food/water bowls on one side and an additional rust-resistant zippered pouch for pet items on the other side.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE OR A COMPUTER PROGRAM LISTING, COMPACT DISC APPENDIX

Not Applicable.

### BACKGROUND OF THE INVENTION

This invention relates generally to providing more comfort and improving pet care to the pet (mainly dogs and cats) primarily while traveling (but this product can be used at home too), and providing convenience to the owner. This product is one compact, complete and convenient “suit-case type” object that has storage space for food/water bowls (included) and additional storage compartments for treats, snacks, leash, collar, tag, toys, blankie, etc. (not included).

Traditionally, pet owners traveling with their pets, mainly dogs and cats, have experienced several problems. First, the pet owner must carry and store their pet's travel essentials, such as food/water bowls, pet beds, crates, numerous travel aids individually, which means the pet owner must also carry and store all these items individually, using several plastic or paper bags. The pet bed, if already used and not freshly laundered, is probably furry and pet “smelly”. Therefore, the pet owner must package the pet bed securely in a bag or the car seat will also become furry and pet “smelly”. Food/water bowls must be clean or these items will also get the car dirty with spills of water and food left in the bowls. The owner must not only concentrate his/her attention on the many items required when traveling with their pet, but how to pack them and where to put them; i.e., health certificates, leash, collar, tags, food, water, toys, blankie, etc.

The pet owner also faces an additional dilemma when traveling with their pet—since most people prefer that pets not sleep on the furniture or bed, as is the case of the hotel/motel owner, friends, or relatives, the pet owner must find a place for the pet to sleep that is comfortable for the pet and acceptable to others. Our product contains the pet bed; hence the bed is not directly on the car seat in the car, and the pet will sleep on his/her own bed rather than the bed or furniture of the host when traveling.

Pet travel can mean car or motion sickness, drooling, shaking and vomiting, or a combination of fear and confusion. If the pet wants to be anywhere but the car, the solution is our product because it reduces the pet's anxiety, helps the pet overcome fear of car rides, is the pet's home away from home, provides the pet his/her own sense of comfort (after all, it's her/her suitcase), provides the pet his/her own smells and the smell of his/her family, has spill-proof food/water bowls, gives the pet his/her own space and provides security to the pet. Therefore, the pet will want to stay on his/her bed while riding in the car. The pet will also be less stressed because he/she is sleeping on his/her own bed. Barking and chewing problems for the pet while in unfamiliar places will be reduced because the pet is sleeping in his/her own bed and therefore less anxious and stressed. Relatives, hotel/motel owners and friends will be more receptive to the traveling pet knowing he/she has his “his/her” own space and bed, thereby keeping the pet fur and smell contained in our product.

Overall, the pet will be more relaxed, less stressed and overall a happier pet while traveling and visiting, making both the pet and the owner welcomed friends while away from home. If flying, the pet owner simply removes the pet bed and places it directly into the airline crate. The owner keeps the remaining unit with his/her luggage and upon landing, simply takes our bed from the airline crate and returns it to our product—after the flight, the pet will feel so much better after having slept in his/her own bed.

### BRIEF SUMMARY OF THE INVENTION

Our invention is a compact, complete and convenient unit and is a must for every cat or dog owner, to be used primarily while traveling but can be used at home too. Our product will help ease owner's worries of pets while traveling, but can be used while at home too.

Our product consists of a “suitcase-type” object with one rust-resistant zipper that opens the entire unit, and is designed with nylon-type fabric, which is treated with a heavy urethane backcoating and a durable water repellent topical/surface. This fabric is durable, washable, and lightweight and is especially designed to enhance the pet owner's décor, available in many colors. The outside pouch, designed with a comfortable, adjustable, durable shoulder strap for easy carrying, has two rust-resistant zippers that opens the two compartments designed to hold all the pet's travel and at home essentials: food/water bowls (included), treats and snacks, leash, etc. The inside of the product is divided into two halves; one half contains an easily removable, washable pet bed that has a rust-resistant zipper for easy removal that is available in many colors. The other half contains durable, washable, food/water bowls on one side and an additional rust-resistant zipper that opens and closes a pouch for pet items on the other side.

Our product is the pet's home at home and away from home. It knows no season and can be used almost anywhere in the world. To the pet owner, our product is compact, complete and convenient and is a necessity (for the pet's comfort) and a token item—a suitcase for all members of the family now, including the dog and cat. The owner can be heard saying “now the dog/cat has his/her own suitcase!” Our product protects the pet owner's car from “shedding” and “hair” problems and eliminates the need for seat covers. When staying at a hotel or motel, our product reassures the motel manager that the pet will stay off their furniture and is less likely to bark because our product reduces the pet's level of anxiety. The likelihood of food and water spills is reduced because our product comes with spill-proof food and water bowls. Our product also reduces the likelihood of “chewing problems” because it has its own storage compartment for the pet's chew and play toys which will be “along for the trip” with the pet.

The most important feature of our product is the contoured pet bed, which every pet should have, offers the pet a sense of security—the dog or cat has his/her own space and can have quite time—a time away from the chaos and commotion of “family” life. Second only to your lap, a pet bed becomes the pet's favorite place to be. If offered at a young age, a pet bed can help train the pet to stay off the furniture. He/she won't want to lie on the sofa, because he/she has his/her own space. Our product contains a pet bed that has a removable pet bed cover that has a rust-resistant zipper for easy removal that is available in many colors.

Pet travel can mean car or motion sickness, drooling, shaking and vomiting, or a combination of fear and confusion. If the pet wants to be anywhere but the car, the solution is our product because it reduces the pet's anxiety, helps the pet overcome fear of car rides, is the pet's home away from home, provides the pet his/her own sense of comfort (after all, it's his/her suitcase), provides the pet his/her own smells and the smell of his/her family, has spill-proof food/water bowls, gives the pet his/her own space and provides security to the pet. The increasing number of pets traveling with their owners evidences pet travel statistics tells us Americans love their pets and treat them like family, as. We believe the above-mentioned problems of traveling with pets, can be overcome with one simple solution—The Portable Pet Hotel.

Our product is not intended to transport or carry pets.

### BRIEF DESCRIPTION OF THE SEVERAL VIEWS OF THE DRAWINGS

FIG. 1 is a front and side perspective view of a soft-shelled, compact, complete, convenient “suitcase-type” object;

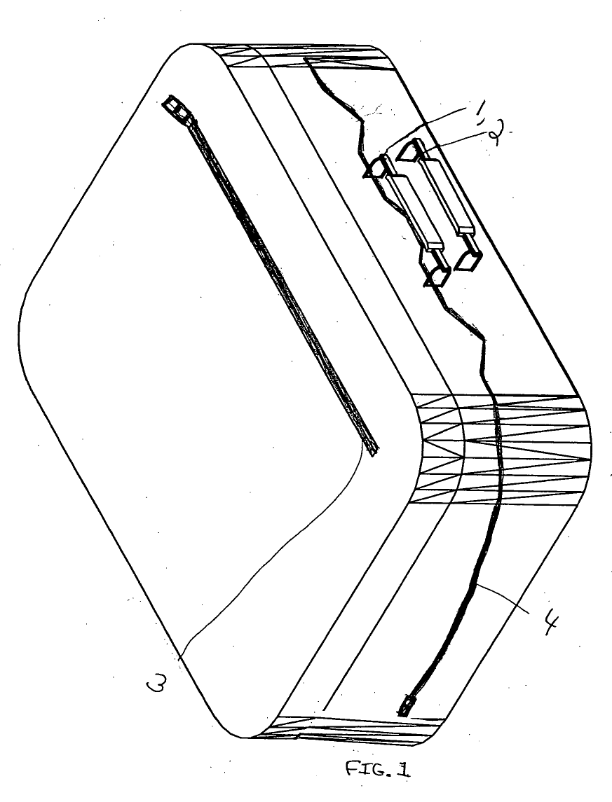

FIG. 2 is the opposite view thereof;

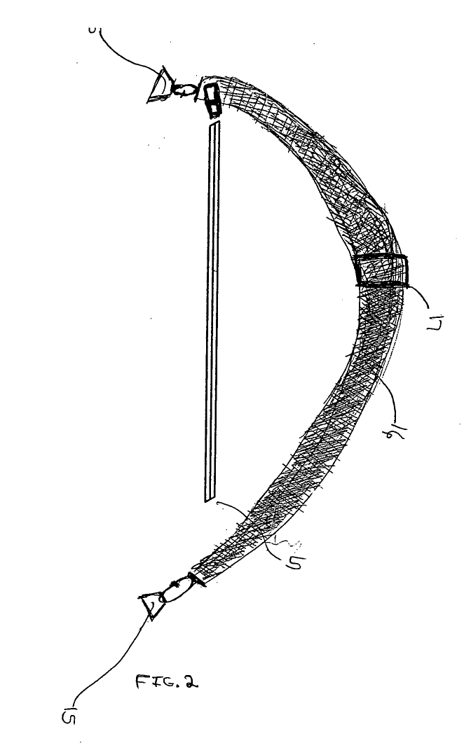

FIG. 3 is the view of the inside of the invention.

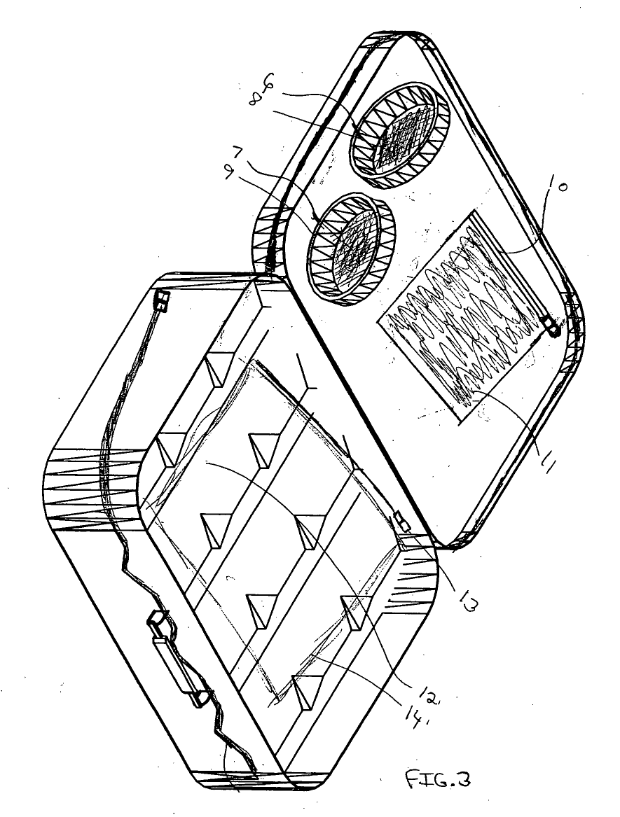

### DETAILED DESCRIPTION OF THE INVENTION

Our product is a portable pet hotel, complete with a contoured pet bed and storage space for daily food, water, play and travel needs in one compact, complete, convenient “suitcase-type” unit. It requires no set-up, no fuss, and no muss. While the pet owner may buy a pet bed already on the market, our product solves the problem of where to put the numerous items required when traveling with their pet: leash, food, bowls, health certificates, etc. and they will also have to “store” their pet's bed. These items are easily and conveniently stored in the product itself—which is not only one compact, complete and convenient unit, but is attractive, lightweight, washable, water repellant and has its own comfortable, durable, adjustable shoulder strap. It can be opened on the back seat of the car, thereby eliminating the “pet fur and pet smell on the car seat” problem; with the pet's own smell on it, the pet is more comfortable and less anxious while traveling. If flying, the pet owner simply removes the pet bed and places it directly into the airline crate. The owner keeps the remaining unit with his/her luggage and upon landing, simply takes our bed from the airline crate and returns it to our product—after the flight, the pet will feel so much better after having slept in his/her own bed.

Our product is the pet's home while at home and particularly while away from home. It knows no season and can be used almost anywhere in the world—homes, kennels, cars, motels, hotels, campgrounds, some trains in the U.S. and many trains and ships in Europe. It comes in various sizes and is anxiety reducing for the pet the pet owner. It is beautifully designed with many colors to match the pet owner's décor and to the owner, it's just another suitcase, but to the pet, it is home, whether at home or away from home. It is easy to clean with a rust-resistant zipper that allows for the removal of the pet bed cover. The entire unit is washable with rust-resistant zippers. There are no “hardware” parts, except for the rust-resistant zippers; therefore no worry about little paws getting caught in “hardware”. Our product has a comfortable, durable, adjustable shoulder strap and soft handles to provide the owner with two options for carrying our product.

It is economical—a small price to pay for the pet's comfort and sense of well-being. Our product makes the pet owner and the pet more hospitable, with the host knowing the pet has his/her own space and place to sleep and rest making for a happy pet, which in turn makes for a welcome pet. Our product gives the pet his/her own suitcase, a must for every dog or cat, whether traveler or “home-body”—everything for the pet in one compact, complete and convenient unit.

The owner no longer needs ANY plastic or paper shopping bags. The pet bed is already secured quite nicely in our product; pet travel items, such as those listed above are secured tightly in the rust-resistant zippered pouches of our product; and food/water bowls are snugly in place during travel thereby eliminating spills and the need to wash them during the trip.

With our product, the owner has five rust-resistant zippers with which to deal; one zipper opens the entire unit; three zippers open the storage pouches; one rust-resistant zipper opens the removable, washable, contoured pet bed cover. Additionally, the owner can simply unzip the main unit, open it, and place it in the seat of the car for the pet, thereby keeping the pet fur and pet smell on the pet bed and off the car seat, furniture or motel/hotel owner's or friend's bed.

The pet will also be less stressed because he/she is sleeping on his/her own bed. It will also be less stressed because he/she is sleeping on his/her own bed. Barking and chewing problems for the pet while in unfamiliar places will be reduced because the pet is sleeping in his/her own bed and therefore less anxious and stressed.

Relatives, hotel/motel owners and friends will be more receptive to the traveling pet knowing he/she has his/her own space and bed, thereby keeping the pet fur and smell contained in our product. Overall, the pet will be more relaxed and a happier pet while traveling and visiting, making both the pet and the owner welcomed friends while away from home.

Our product is a textile product; we take raw materials, cut to the pattern and sew using sewing machines.

Our product provides an improvement in other “similar” products in that while another product may provide a “shade device in the form of a canopy” or have a “drawer-type unit” with hinges upon which to “slide” out a storage compartment, our product is easily opened with lots of space for the pet and no obstacles to step over to get to their pet bed or food/water bowls. While another product my have “hardware” in order to function, our product is a soft-shelled, flexible unit with only rust-resistant zippers on the main unit, and plastic clasps on the comfortable, durable, adjustable shoulder strap to function, thereby eliminating the possibility of the pet getting his/her little paws caught in the “hardware”.

1. I claim this invention to be a soft-shelled, flexible portable pet hotel which is one compact, complete and convenient “suitcase-type” unit, without “hardware” except for the rust-resistant zippers on the main unit, and plastic clasps on the comfortable, durable, adjustable shoulder strap, that has storage space for daily food, water and play and travel needs and also comes with a washable, contoured foam pet bed that has a washable cover that has a rust-resistant zipper for removal.
